(19) United States
(12) Patent Application Publication
(10) Pub. No.: US 2024/0367505 A1
(43) Pub. Date: Nov. 7, 2024

(54) EXTRUDED FLAP FOR A DEVICE FOR SHUTTING OFF AN AIR INLET OF A MOTOR VEHICLE FRONT END

(71) Applicant: Valeo Systemes Thermiques, Le Mesnil-Saint-Denis (FR)

(72) Inventors: Frédéric Vacca, Le Mesnil-Saint-Denis (FR); Victor Manuel Minero Ramales, Le Mesnil-Saint-Denis (FR); Karim Arab, Le Mesnil-Saint-Denis (FR); Enzo Mitidieri, Le Mesnil-Saint-Denis (FR); Laura Marion, Le Mesnil-Saint-Denis (FR)

(73) Assignee: Valeo Systemes Thermiques, Le Mesnil-Saint-Denis (FR)

(21) Appl. No.: 18/580,821

(22) PCT Filed: Jul. 19, 2022
(86) PCT No.: PCT/EP2022/070175

§ 371 Date: Jan. 19, 2024

(30) Foreign Application Priority Data
Jul. 21, 2021 (FR) 2107871

(51) Int. Cl. B60J 10/21

(52) U.S. Cl. CPC B60J 10/21; B60Y 2410/113

(57) ABSTRACT

A flap for a motor vehicle shut-off device is disclosed. The flap has a flap body and at least one end piece configured to be assembled with said flap body, where the flap body has a wall having an interior face defining an internal cavity, and an exterior face. The end piece includes a core designed to be inserted into the internal cavity of the flap body, and at least one protuberance configured to press against the exterior face of the wall of said flap body when said at least one end piece is push-fitted into said flap body.

The present invention relates to a flap for a shut-off device, and more specifically a device for shutting off an air inlet of a motor vehicle front end.

Motor vehicle front ends are generally made up of two main air inlets, referred to as the top route and the bottom route, that are separated by a bumper beam. The heat exchangers of the motor vehicle, such as the one used for the vehicle-interior air conditioning and/or the one used for cooling the engine, for example, are generally placed behind this bumper beam.

It is also known practice to arrange, in the path of air passing through the main air inlets, more generally the bottom route, a support frame comprising a multiplicity of flaps that are mounted so as to pivot about parallel axes and are able to assume a multiplicity of different angular positions, between an open position and a shut-off position, under the action of suitable control means.

A shut-off device resembling a louver blind is thus obtained that makes it possible to adjust the flow rate of air passing through the air inlets and arriving at the heat exchangers. It is thus possible to optimize the effectiveness of these heat exchangers as necessary by varying the amount of air they receive. In addition, at high speed, the flaps in the shut-off position make it possible to reduce the drag coefficient of the vehicle and thus improve the aerodynamics of said vehicle.

The flaps of such shut-off devices may in particular comprise an extruded flap body, arranged at the ends of which are end pieces that allow the connection to the support frame. However, in order for these end pieces to remain in place inside the flap body, or in order to prevent the end pieces from damaging the flap body when they are put in place, small manufacturing tolerances are necessary. This production quality is difficult to achieve and very costly due to the materials and dimensions of the components.

One of the aims of the present invention is therefore to overcome at least some of the drawbacks of the prior art by proposing a flap comprising an improved connection between the flap body and the end pieces. The present invention therefore relates to a flap for a shut-off device, notably a motor vehicle shut-off device, said flap comprising a flap body and at least one end piece configured to be assembled with said flap body, wherein:
a. said flap body comprises a wall having an interior face defining an internal cavity, and an exterior face, and
b. said at least one end piece comprises a core designed to be inserted into the internal cavity of the flap body,
the end piece comprising two disjointed lips facing one another, each lip comprising a curved portion comprising an interior face and an exterior face.

According to the invention, each of the lips comprises at least three protuberances situated on said interior face of the lip and configured to press against the exterior face of the wall of said flap body when said at least one end piece is push-fitted into said flap body. Moreover, each protuberance is substantially gully-shaped.

Thus, as will be seen in detail hereinafter, the protuberances apply force to the flap body so as to hold the flap body between the core of the end piece and the protuberance. As the flap body is being assembled with the end piece, the protuberance applies force to the flap body causing it to press firmly against the core body of the flap end piece. The flap body is thus forcibly clamped between the protuberance and the core of the end piece. This makes it possible both to hold the flap body firmly and to adjust the position of the flap body as it is being assembled with the end piece, thereby limiting the risks of the flap body breaking. The fact that there are at least three protuberances positioned along each lip improves the stability of the assembly. The gully shape of the protuberances makes the end piece easier to push-fit into the flap body.

According to nonlimiting embodiments, the flap may further comprise one or more of the following additional features taken alone or in any technically possible combination.

In one aspect according to the invention, the protuberance is formed as a single piece with the end piece.

In one aspect according to the invention, the end piece and the protuberance contain a plastics material.

In one aspect according to the invention, the end piece and the protuberance are made of a fiber-reinforced plastic.

In one aspect according to the invention, the end piece and the protuberance are made of a glass fiber-reinforced plastic.

In one aspect according to the invention, the end piece and the protuberance are made of plastic containing 30% glass fiber and are notably made of the polyamide GGFR30.

In one aspect according to the invention, the end piece is made up of two parts fitting one inside the other.

In one aspect according to the invention, the protuberances are spaced from one another by a spacing.

In one aspect according to the invention, the spacing between each of the protuberances comprised on one lip varies.

In one aspect according to the invention, the spacing between each of the protuberances is the same.

In one aspect according to the invention, the spacing between each of the protuberances varies on just one of the two lips.

In one aspect according to the invention, at least one lip comprises at least one opening so that part of the flap body is not in contact with said lip. In other words, at least part of the flap body is free.

In one aspect according to the invention, the flap body comprises at least one apex, preferably two apexes. As a preference, said apexes correspond to the free parts described hereinabove.

In one aspect according to the invention, at least one lip comprises protuberances over the entirety of its interior surface.

In one aspect according to the invention, at least one lip comprises a zone with protuberances spaced by a spacing, and at least one zone free of protuberances. As a preference, each of the lips comprises a zone with protuberances spaced by a spacing, and at least one zone free of protuberances. As a preference, the zone with protuberances is a central zone and the zones without protuberances are ends of the lip.

In one aspect according to the invention, each of the lips comprises the same number of protuberances.

In one aspect according to the invention, each of the lips comprises a different number of protuberances.

In one aspect of the invention, the protuberances that are on one lip face the protuberances of the other lip.

In one aspect according to the invention, the core of the end piece comprises at least a first face and a second face, at least one of the two, first or second, comprising at least one material-free recess. As a preference, the first and second face both have material-free recesses.

In one aspect according to the invention, the material-free recess is a blind hole.

In one aspect according to the invention, at least one protuberance faces a material-free recess of the core.

In one aspect according to the invention, each protuberance has a height that is less than the height of the core.

In one aspect according to the invention, each protuberance has a base, a wall of a height h extending from this base and a summit at the end of the wall opposite to the base, the base having a surface area larger than the surface area of the summit.

In one aspect according to the invention, the protuberance is formed by the base, the wall, the summit and the interior face of the lip on which it is situated.

In one aspect according to the invention, the lips have a height that is less than that of the core.

In one aspect according to the invention, the lips have a height J that is substantially equal to the height h of each protuberance.

In one aspect according to the invention, the core comprises a base, a wall extending from the base and a summit, the surface area of the base being greater than the surface area of the summit.

In one aspect according to the invention, the body of the flap is produced using extrusion.

In one aspect according to the invention, the body of the flap has a thickness of between 1 mm and 3 mm, preferably of 2 mm.

In one aspect according to the invention, said at least one end piece is produced by injection molding.

The invention also relates to a motor vehicle shut-off device comprising at least one flap as described in the present application.

The invention also relates to a motor vehicle front end module comprising a shut-off device as described in the present application.

Other features and advantages of the invention will become more clearly apparent on reading the following description, given by way of illustrative and nonlimiting example, and from the accompanying drawings, in which:

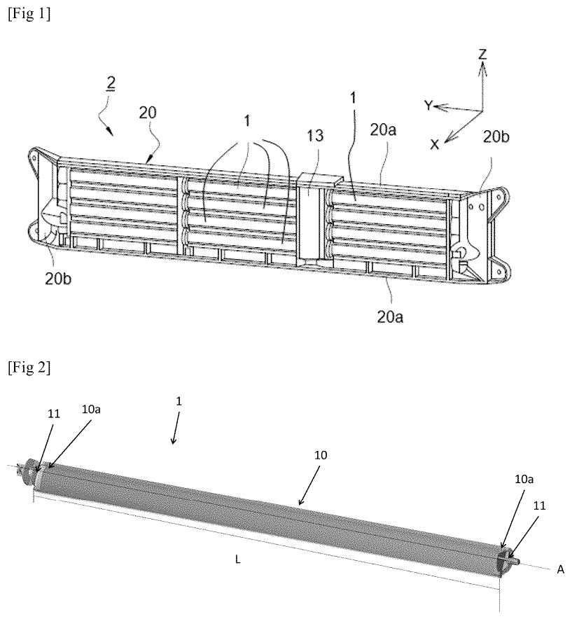

FIG. 1 is a schematic illustration, in face-on perspective, of a motor vehicle shut-off device in the shut-off position, said shut-off device comprising at least one flap according to one nonlimiting embodiment of the invention,

FIG. 2 is a schematic illustration, in perspective, of a flap,

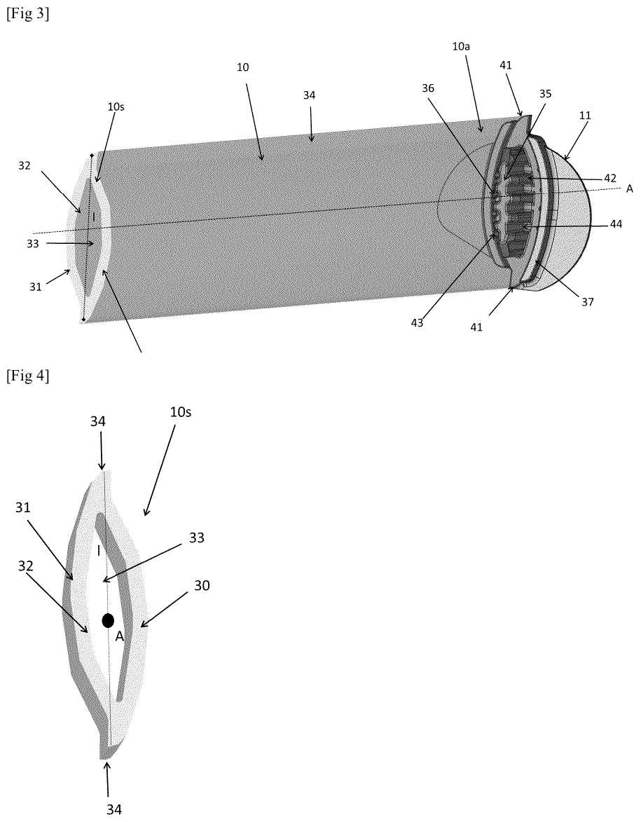

FIG. 3 is a schematic illustration of a flap end,

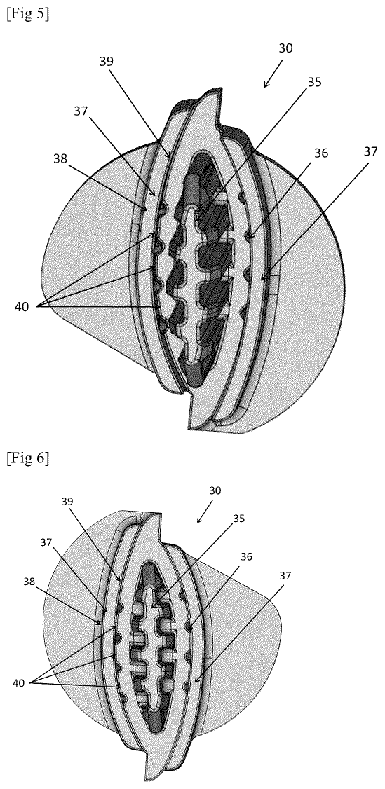

FIG. 4 is a schematic illustration, in cross section, of the flap body,

FIG. 5 is a schematic illustration, in perspective, of an end piece,

FIG. 6 is a schematic illustration, in perspective, of an end piece, from a different angle,

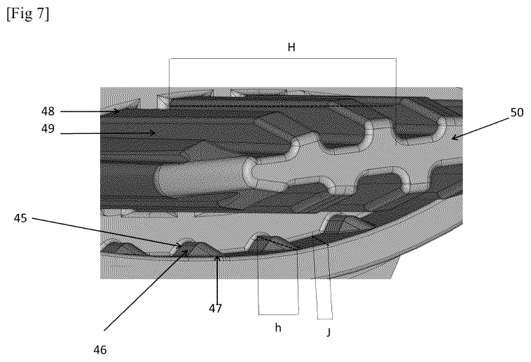

FIG. 7 is a schematic illustration, in perspective, of part of an end piece.

In the various figures, identical elements bear the same reference signs.

The following embodiments are examples. Although the description refers to one or more embodiments, this does not necessarily mean that each reference sign refers to the same embodiment, or that the features apply only to one embodiment. Individual features of various embodiments may also be combined or interchanged to create other embodiments.

In the present description, certain elements or parameters may be indexed as, for example, first element or second element, as well as first parameter and second parameter or even first criterion and second criterion, etc. In this case, this is simple indexing to differentiate and designate elements or parameters or criteria that are similar but not identical. This indexing does not imply that one element, parameter or criterion takes priority over another and such designations can easily be interchanged without departing from the scope of the present description. Likewise, this indexing does not imply any chronological order, for example, in assessing any given criteria.

Elements that are identical in terms of structure or function and that appear in various figures retain the same references, unless indicated otherwise.

The flap 1 for a motor vehicle shut-off device 2 is described with reference to FIGS. 1 to 5. A motor vehicle is to be understood to mean any type of motorized vehicle. The flap 1 comprises a flap body 10 and at least one end piece 11 configured to push-fit into said flap body 10. The flap 1 forms part of a shut-off device 2 illustrated in FIG. 1.

Motor vehicle front ends are generally made up of two main air inlets, referred to as the top route and the bottom route, that are separated by a bumper beam. The heat exchangers of the motor vehicle, such as the one used for the vehicle-interior air conditioning and/or the one used for cooling the motor vehicle engine, for example, are generally placed behind this bumper beam. The shut-off device 2 is placed in the path of air passing through the main air inlets, more generally the bottom route. It comprises a multiplicity of flaps 1 with flap bodies 10 that are mounted so as to pivot about parallel axes and are able to assume a multiplicity of different angular positions, between an open position and a shut-off position, under the action of suitable control means. The shut-off device 2 thus resembles a louver blind that makes it possible to adjust the flow rate of air passing through the air inlets and arriving at the heat exchangers. It is thus possible to optimize the effectiveness of these heat exchangers, depending on the requirements, by varying the amount of air that they receive. In addition, at high speed, the flap bodies 10 in the shut-off position make it possible to reduce the drag coefficient of the vehicle and thus improve the aerodynamics of said vehicle.

The shut-off device 2 is illustrated in FIG. 1. A reference trihedron XYZ will be used in FIG. 1. The axes of this trihedron may also correspond to the different orientations of the motor vehicle. The X axis may thus correspond to the axis of the length of the vehicle, the Y axis to the axis of its width and the Z axis to that of its height. FIG. 1 is a schematic perspective illustration of a shut-off device 2 in the shut-off position. This FIG. 1 more exactly shows the outer face of said shut-off device 2, i.e. the face directed toward the outside of the motor vehicle. Said shut-off device 2 comprises a support frame 20 comprising in particular two longitudinal crossmembers 20a, extending parallel to the Y axis of the trihedron, and at least two lateral uprights 20b, extending parallel to the Z axis of the trihedron and connecting said longitudinal crossmembers 20a. In one nonlimiting embodiment, the support frame 20 is made from plastics material and the two longitudinal crossmembers 20a and the at least two lateral uprights 20b are obtained by injection molding. In order to improve the stiffness of said support frame 20, it can be molded in one piece.

The one or more flaps 1 are installed within said support frame 20. When there is a plurality of flaps 1, they form rows of flaps 1 parallel to each other and forming a set of flaps 1, as illustrated in the figure. At one of the ends of the flap 1 or the set of flaps 1, there is placed a control element 13 allowing the one or more flaps 1 to rotate about a pivot axis A (illustrated in FIG. 2 to FIG. 7), between an open position (not shown), in which the one or more flaps 1 are disposed such that a flow of air can pass through the shut-off device 2, in particular inside the support frame 20, and a shut-off position illustrated in FIG. 1, in which the one or more flaps 1 are arranged such that a flow of air cannot pass through the shut-off device 2. The pivot axis A is parallel to the axis Y of the trihedron. As illustrated in FIG. 1, it is possible to have a device 2 for shutting off a motor vehicle front end air inlet that has a plurality of sets of flaps 1 extending across the entire width of the support frame 20. The sets of flaps 1 may be separated by the control element 13 in order to ensure their synchronous rotation. The control element 13 comprises a link rod (not illustrated) and an actuator (not illustrated) which is configured to apply to the link rod a translational movement along the Z-axis of the trihedron. The actuator may be electrical or pneumatic. When the shut-off device 2 comprises several flaps 1, all the flaps 1 are connected to the same link rod. All of the flaps 1 thus move from an open position to a shut-off position synchronously.

As illustrated in FIG. 2, a flap 1 comprises a flap body 10 and two end pieces 11 configured to push-fit into said flap body 10. The flap body 10 of the flap 1 is described in detail below. The flap body 10 is elongate along its pivot axis A and is of length L. The flap 1 has two ends 10a which are each configured to accept an end piece 11.

Only one end 10a is illustrated in FIG. 3. The flap body 10 has a cross section 10s of width 1. The transverse cross section 10s of the flap body 10 may more particularly have a substantially oval profile. It is nevertheless entirely possible to imagine other shapes for the profile of the transverse cross section 10s of the flap body 10, such as for example rectangular or with a hollow central portion from which fins emerge.

A close-up view of a transverse cross section 10s of the flap body 10 is illustrated in FIG. 4. As illustrated in FIG. 4, the flap body 10 comprises a wall 30 which comprises an exterior surface 31 and an interior surface 32, said interior surface delimiting an internal cavity 33. The wall 30 of the flap body 10 is produced by extrusion of material. In one nonlimiting embodiment, the material extruded is a metal. That allows said wall to have a wall thickness of between 0.1 and 2.5 mm. In a nonlimiting embodiment variant, the wall thickness is between 0.2 and 0.3 mm. In another nonlimiting embodiment, the material is a thermoplastic polymer. That allows said wall to have a wall thickness of between 0.5 and 1 mm. In one nonlimiting embodiment variant, the wall thickness is between 0.5 and 3 mm, preferably between 0.8 and 2.5 mm, and preferably between 0.8 and 2 mm. In one nonlimiting embodiment variant, the thermoplastic polymer is polypropylene. In one nonlimiting embodiment, the flap is made of PPGF30, of polyamide, or of any other material suited to being extruded. This is an economical material. The internal cavity 33 is defined by the internal surface of the wall 30. It will be noted that a flap body 10 extruded in this way makes it possible to reduce the mass of the flap 1 by comparison with a solid flap body, generally of omega-shaped cross section and obtained by injection molding of plastics.

As illustrated in FIG. 3 and FIG. 4, the flap 10 further comprises at least one apex 34. In the nonlimiting example illustrated, it comprises two apexes 34. In one nonlimiting embodiment, the apexes 34 are solid as illustrated in FIG. 4. In an embodiment which has not been depicted here, the apexes 34 may also be hollow, bordered by a connecting element. The apexes 34 correspond to the ends of the transverse cross section 10s of the flap body 10. They extend parallel to the pivot axis A. They make it possible to achieve a good seal when the flap body 10 is in a shut-off position. Specifically, in instances in which there are a plurality of flaps 1 in the shut-off device 2, the apexes 34 will come into contact with the apexes 34 of the adjacent flap bodies 10 which are situated on each side of the flap body 10 of the flap 1 concerned, when the flap bodies 10 of the set of flaps 1 are in a shut-off position, so as to prevent air as well as water or dust from passing. Thus, as illustrated in FIG. 4, the flap 1 comprises a single internal cavity 33 defined by the internal surface 32 of the wall 30 of the flap body and the apexes 34 when these are solid.

FIG. 5 and FIG. 6 show the end piece 11 of a flap 1. End pieces 11 are disposed at each end 10a of the flap body 10. In the present case, reference is made to the ends of the flap body 10 in the longitudinal direction L. The flap 1 thus comprises two end pieces 11 as illustrated in FIG. 2. The end pieces 11 may have different shapes, or else identical shapes, this allowing savings to be made on production costs. In one nonlimiting embodiment, the end pieces 11 are molded together with said flap body 10. This simplifies the assembling of the flap 1. In one nonlimiting embodiment, an end piece 11 is made of polyamide. In one nonlimiting embodiment, an end piece 11 is made of glass fiber-reinforced polyamide, this being for example the material PA66 GF30 which is a fiber-reinforced polyamide with a glass-fiber content of 30%. The end pieces 11 are preferably made by injection molding.

As illustrated in FIG. 5 or FIG. 6, an end piece 11 comprises a protrusion, otherwise known as a core 35, projecting parallel to the pivot axis A so as to be fitted into the internal cavity 33 of the flap body 10. The core 35 is for driving the flap 1 during operation thereof. The core 35 allows the end piece 11 to be push-fitted into the internal cavity 33 of the flap body 10. This nonlimiting embodiment will be considered, by way of nonlimiting example, in the remainder of the description.

As illustrated in FIG. 5 and FIG. 6, the end pieces 11 comprise at least a plurality of protuberances 36. The protuberances 36 are configured to press against the exterior surface 31 of the flap body 10. The protuberances 36 thus hold the flap body 10 in the end piece 11. As a preference, the protuberances 36 are formed as one piece with the end piece 11. The end piece 11 and the protuberances 36 are for example made of glass fiber-reinforced plastic such as GGFR30.

In the embodiment of FIG. 5 and FIG. 6, the end piece comprises two disjointed lips 37 facing one another, these being situated one on each side of the core 35. Each lip 37 comprises a curved portion comprising an interior face 39 and an exterior face 38, the protuberance 36 being situated on said interior face 39 of the lip 37. The protuberances 36 are spaced from one another by a spacing 40. In the embodiment depicted in FIGS. 5 and 6, the spacing 40 between each of the protuberances 36 is the same. In an embodiment not depicted here, the protuberances 36 are situated substantially on the central part of each of the lips 37. The ends of the lips 37 have no protuberances 36. In an embodiment not depicted here, the protuberances 36 could be present over the entirety of the interior surface 39 of each of the lips. In the embodiment depicted here, each lip comprises the same number of protuberances 36. In an embodiment not depicted here, each lip could comprise a different number of protuberances 36. In an embodiment not depicted here, it might be possible for just one lip to comprise protuberances, or for one of the two lips to have just one protuberance. In the embodiment depicted here, the lips 37 comprises an opening 41 such that part of the flap body 10 is left free, notably the part comprising the apex 34. This ensures that the device comprising the flap will seal tightly. In the embodiment depicted here, the protuberances 36 present on one of the lips 37 face the protuberances 36 situated on the second lip 37.

In the embodiment depicted here, the core 35 of the end piece 11 comprises at least a first face 42 and a second face 43, at least one of the two, first 42 or second 43, comprising at least one material-free recess 44. In the embodiment depicted here, each of the first face 42 and second face 43 comprises several material-free recesses 44 in the form of blind holes. In this instance here, each protuberance 36 faces a material-free recess 44 of the core 35. As the flap body 10 is being push-fitted into the end piece 11, the flap body 10 may deform slightly at the protuberances 36. Having a material-free recess 42 on the core 35 facing each of the protuberances makes it possible to accommodate this deformation.

As depicted in FIG. 7, the protuberances 36 have a height h which is less than the height H of the core 35. In this embodiment, each protuberance has a base 45, a wall 46 of a height h extending from this base 45 and a summit 47 at the end of the wall 46, the base 45 having a surface area larger than the surface area of the summit 46. Thus, the protuberance 36 is gully-shaped or half-cone-shaped, making the insertion of the flap body 10 into the end piece 11 easier. Likewise, the core 35 comprises a base 48, a wall 49 and a summit 50, the base 48 of the core 35 having a surface area greater than the surface area of the summit 50 of the core 35. The core thus has a gully shape likewise so as to facilitate the insertion of the flap body.

The lips 37 have a height J which is less than the height H of the core 35. This ensures better retention of the flap body without adding unnecessary stress. The height J of the lips 37 is substantially equal to the height h of the protuberances 36.

Of course, the description of the invention is not limited to the embodiments described above and to the field described above.

1. A flap for a a motor vehicle shut-off device, said flap comprising:
a flap body; and
at least one end piece configured to be assembled with said flap body, wherein:
said flap body comprises a wall having an interior face defining an internal cavity, and an exterior face, and
said at least one end piece comprises a core configured to be inserted into the internal cavity of the flap body,
the end piece comprising two disjointed lips facing one another, each lip comprising a curved portion comprising an interior face and an exterior face,
wherein each of the lips comprises at least three protuberances situated on said interior face of the lip and configured to press against the exterior face of the wall of said flap body when said at least one end piece is push-fitted into said flap body, and
wherein each protuberance is substantially gully-shaped.

2. The flap as claimed in claim 1, wherein the protuberance is formed as one piece with the end piece.

3. The flap as claimed in claim 1, wherein the core of the end piece comprises at least a first face and a second face, at least one of the two, first or second, comprising at least one material-free recess.

4. The flap as claimed in claim 3, wherein each protuberance faces a material-free recess of the core.

5. The flap as claimed in claim 1, wherein the body of the flap is produced using extrusion.

6. The flap as claimed in claim 5, wherein the body of the flap has a thickness of between 1 mm and 3 mm.

7. A motor vehicle shut-off device comprising at least one flap as claimed in claim 1.

8. A motor vehicle front end module comprising a shut-off device as claimed in claim 7.
